(19) United States
(12) Patent Application Publication
(10) Pub. No.: US 2026/0213313 A1
(43) Pub. Date: Jul. 23, 2026

(54) SECONDARY CELL

(71) Applicant: Northvolt AB, Stockholm (SE)

(72) Inventors: Kenya SHATANI, Stockholm (SE); Michael SHAUGHNESSY, Västerås (SE)

(21) Appl. No.: 19/142,212

(22) PCT Filed: Dec. 20, 2023
(86) PCT No.: PCT/EP2023/086829

§ 371 Date: Jun. 22, 2025

(30) Foreign Application Priority Data
Dec. 23, 2022 (SE) 2251577-9

(51) Int. Cl. H01M 50/169; H01M 10/04; H01M 50/107; H01M 50/152

(52) U.S. Cl. CPC H01M 50/169; H01M 10/0409; H01M 10/0422; H01M 10/0431; H01M 50/107; H01M 50/152

(57) ABSTRACT

A cylindrical secondary cell (10) comprising a cylindrical enclosure (11) having a lid (1), an electrode roll (20) arranged in the cylindrical enclosure (11), a current collector disc (15) to be arranged in direct electrical contact with the electrode roll (20), wherein the lid (1) or the current collector disc (15) comprises a number of recessed contact portions (2), the area of the recessed contact portions (2) being 50 to 80 percent of the total area of the lid (1), and wherein the current collector disc (15) is configured to be attached to the lid (1).

### TECHNICAL FIELD

The present disclosure generally pertains to cylindrical secondary cells and more precisely to a cylindrical secondary cell comprising a current collector disc and a lid attached to said current collector disc.

### BACKGROUND

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### SUMMARY

In view of at least the above considerations, there is provided, according to aspects of the present disclosure, an arrangement for a lid of a secondary cell to be reliably in mechanical and/or electrical contact with a current collector disc of said secondary cell.

In particular, according to an aspect of the present of the present disclosure, there is provided a cylindrical secondary cell comprising a cylindrical enclosure having a lid, an electrode roll arranged in the cylindrical enclosure, and a current collector disc arranged in direct electrical contact with the electrode roll and configured to be attached to the lid. Further, the lid or the current collector disc comprises a number of recessed contact portions, the area of the recessed contact portions being 50 to 80 percent of the total area of the lid or current collector disc.

There are a number of advantages associated with such an approach, one being that the recessed contact portions allow for facilitated electrolyte filling. The recessed contact portions provide a space for the electrolyte to flow in. Further, the recessed contact portions preferably have an area covering a majority of the total area of the lid or the current collector disc.

The recessed contact portions may be generally trapezoid in shape, or may have the shape of a truncated annulus. The cylindrical secondary cell may comprise both a positive terminal and a negative terminal at one and the same end. The cylindrical secondary cell lid may be arranged in direct electrical contact with an enclosure of the cylindrical secondary cell. The cylindrical enclosure may act as the negative terminal.

In the case where the recessed contact portions are on the lid, the recessed contact portions can provide an electrical contact with the current collector disc. The size of the electrical connection area increases with an increased size of the recessed contact portions.

Further, the recessed contact portions can provide mechanical support to the lid, increasing its stability in the case of a crash event or similar. The recessed contact portions may for example provide stability in terms of deformation of the lid, preventing or mitigating a deformation of the cell during a crash event. Furthermore, the cell itself may become more stable comprising a lid with recessed contact portions. Simultaneously, the recessed contact portions may also provide features for gripping or in other ways physically handling the cell, since the recessed contact portions provides structural features to the lid. For example, in comparison to a case where the lid is substantially flat, there are less structural features to utilize when moving the cell, or similar. The present disclosure is therefore advantageous in that the recessed contact portions facilitate handling of the cell.

In another example, the recessed contact portions are on the current collector disc, the recessed contact portions can provide an electrical contact with the electrode roll. The recessed contact portions may be the only part of the current collector disc that is in electrical connection with the conductive sheet on the electrode roll.

The size of the electrical connection area increases with an increased size of the recessed contact portions. Further, the recessed contact portions can provide mechanical support to the current collector disc, increasing its stability in the case of a crash event or similar. The recessed contact portions may for example provide stability in terms of deformation of the current collector disc, preventing or mitigating a rupture of the electrode roll during a crash event.

In another example, the lid and the current collector disc both comprise recessed contact portions. The lid and the current collector disc may be arranged such that the respective recessed contact portions match each other. This means that the lid and the current collector disc may mate with each other through the recessed contact portions, in a male/female connection. This is advantageous in that the electrical connection area increases.

The recessed contact portions may also be arranged opposite to each other. The recessed contact portions of the lid may then be mirrored in relation to the recessed contact portion of the current collector disc, such that a bottom of the recessed contact portions abut each other. This is advantageous in that the abutment area may work as an attachment area between the lid and the current collector disc. For example, the abutment area may be a welding area.

In an even further example, the recessed contact portions may be arranged opposite to each other, such that the recessed contact portions of the lid are mirrored in relation to the recessed contact portion of the current collector disc, forming a cavity between the recessed contact portions of the lid and the current collector disc. This is advantageous in that the cavities formed may allow for a flow of electrolyte.

Furthermore, the recessed contact portions may also provide a keying feature for the lid and the current collector. The keying feature is advantageous in that in may ensure that the lid and the current collector disc are oriented in the desired way, minimizing the risk for an incorrect orientation. An incorrect orientation could possibly lead to mechanical damage, or loss of electrical connection.

Another advantageous aspect of the present disclosure is that the cylindrical enclosure itself may act as the negative terminal, yielding a plurality of options to mount the cell, not being restricted to a certain position of the current collector disc or the lid. Further, the lid does not have to be electrically insulated from the cylindrical enclosure or the current collector disc, which facilitates manufacturing of the cell. The cell therefore becomes more versatile, enabling more freedom in terms of design choices, which is advantageous since the cell may be adapted to different end products or applications.

In some examples, the lid is configured to be attached to the cylindrical enclosure by an attachment between the current collector disc and the lid.

The current collector disc and the electrode roll can form a reliable electrical and thermal connection by being held in place by the lid. Moreover, the lid and the cylindrical enclosure can form a reliable connection to form an enclosed cell. Further, attaching the lid to the current collector disc may simplify manufacturing and assembly of the cell. The lid and the current collector disc may then be inserted and attached to the cylindrical enclosure as one unit, instead of being separately installed in the same.

In an example, the lid is configured to be attached to the cylindrical enclosure by the lid being welded to the current collector disc. The lid and the current collector disc may be welded together before they are installed in the cylindrical enclosure.

In a further example, a weld interface between the lid and the current collector disc, after welding, is at least partly visible such that the weld may be inspected. This is advantageous in that it increases the chances of noticing production damages during manufacturing. When the weld interface is visible, the damaged cells can be discarded before use, decreasing the risk of battery malfunction during use. The weld interface can be comprised by the recessed contact portions, for example. As previously mentioned, an increased area of the recessed contact portions increases the electrical connection area. An increased area of the recessed contact portions is also beneficial as it simplifies positioning of the weld, e.g. laser weld lines, within the recessed contact portion.

Furthermore, attaching the current collector disc to the lid may also facilitate the manufacturing process. The recessed contact portions provide a straightforward welding area. It is easier to weld from the lid to the disc, than to weld from an outside of the cylindrical enclosure. Welding from an outside of the cylindrical enclosure may introduce inconsistencies in the welding seam since the welding seam may be hard to inspect. The weld seam is visible when the lid and the current collector disc are welded together. Further, the weld seam can be inspected prior to arranging the lid and the current collector disc in the cylindrical enclosure. This is advantageous in that the entire cell does not have to be discarded if the weld is faulty. Instead, the lid and the current collector disc may be exchanged before arranged in the cell, which increase the reliability and the overall quality of the cell.

Furthermore, according to an example, the lid and the current collector disc extends substantially in parallel. The lid and the current collector may also have substantially the same shape and size. For example, a circular shape, or any other shape corresponding to the shape of the cylindrical enclosure. According to an example, the lid and the current collector disc are welded to the enclosing. Thus, the same manufacturing method can be used for both attaching the lid to the current collector, and attaching both to the cylindrical enclosure. This is advantageous in that the number of manufacturing methods needed to produce a cell may be decreased.

According to a further example, the lid comprises a flange to be arranged in direct electrical contact with the cylindrical enclosure of the cylindrical secondary cell. In the case where the recessed contact portions are located on the lid, the extension of the recessed contact portions in a longitudinal direction of the cylindrical secondary cell substantially equals the extension of the flange in the longitudinal direction of the cylindrical secondary cell. The flange is advantageous since it may facilitate the attachment of the lid and the current collector disc to the cylindrical enclosure. Further, the flange may be used as weld interface when welding the lid to the cylindrical enclosure.

In one example, the recessed contact portions and the flange extend in the same axial direction. In another example, the recessed contact portions and the flange may extend in axially opposite directions.

In another example, the extension of the recessed contact portions in the longitudinal direction of the cylindrical secondary cell exceeds the extension of the flange in the longitudinal direction of the cylindrical secondary cell.

According to another aspect of the present disclosure, there is provided a method for assembling a cylindrical secondary cell substantially as described above, wherein the assembling the cylindrical secondary cell comprises arranging the current collector disc in direct electrical contact with the electrode roll, and attaching the lid to the current collector disc. The lid can be welded to the current collector disc prior to arranging the current collector disc in contact with the electrode roll. In another example, the lid can be welded to the current collector disc when the current collector disc is already arranged in contact with the electrode roll.

Therefore, the method further comprises arranging the current collector disc in the cylindrical enclosure, arranging the lid on the current collector disc in the cylindrical enclosure, attaching the lid to the current collector disc by welding from a top surface of the lid, such that the lid and the current collector disc are welded together in the cylindrical enclosure.

### BRIEF DESCRIPTION OF THE DRAWINGS

Aspects of the present disclosure will be described, by way of example only, and with reference to the following figures, in which:

FIG. 1a-b shows cross-sectional views of an example cylindrical secondary cell wherein a lid and a current collector disc are attached to a cylindrical enclosure;

FIGS. 2a-c shows cross-sectional views of a portion of an example cylindrical secondary cell wherein a lid and a current collector disc are attached to a cylindrical enclosure.

FIG. 3 shows a perspective view of a lid with recessed contact portions;

FIG. 4 shows a cross-sectional view of a lid or a current collector disc with the recessed contact portions;

FIG. 5 shows a cross-sectional view of a portion of a lid or a current collector disc with recessed contact portions and a flange.

### DETAILED DESCRIPTION

The present disclosure is described in the following way by way of a number of illustrative examples. It will be appreciated that these examples are provided for illustration and explanation only and are not intended to be limiting on the scope of the disclosure.

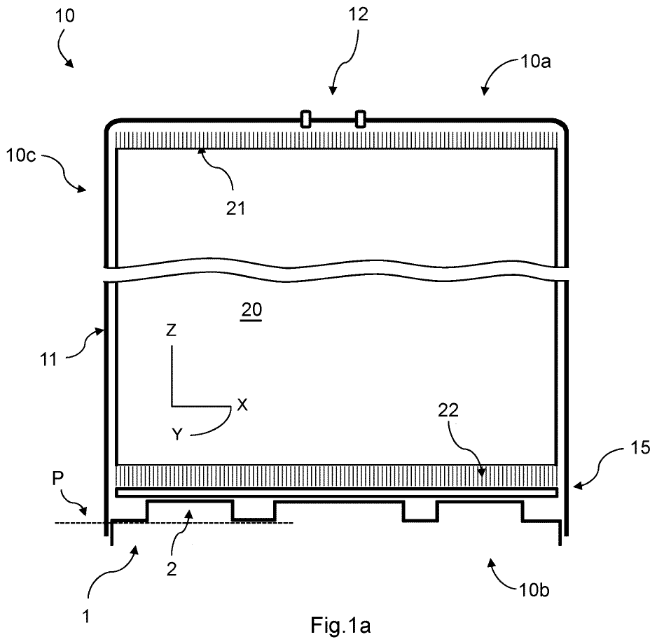

FIG. 1a shows a cross-sectional view of an example cylindrical secondary cell 10 (hereinafter referred to as cell), wherein a lid 1 and a current collector disc 15 are arranged. In the example shown in FIG. 1a, the cell 10 is circular cylindrical. The cell 10 comprises a cylindrical enclosure 11 having a first enclosure end 10a, an opposite second enclosure end 10b and an enclosure sidewall 10c that extends between the enclosure ends 10a, 10b. The lid 1 and the current collector disc 15 are attached to a cylindrical enclosure 11.

In the exemplified embodiment, the first and second enclosure ends 10a, 10b are circular. The enclosure sidewall 10c is circular cylindrical. The cell 10, and thus its enclosure sidewall 10c, may be elongate and extend along a longitudinal axis (Z-axis in FIG. 1). The enclosure ends 10a, 10b may extend in planes (XY-planes in FIG. 1) that are perpendicular to the longitudinal axis.

As is illustrated, the first enclosure end 10a, may be formed in one piece with the enclosure sidewall 10c. The second enclosure end 10b can be open, or a separate lid 1 can, as shown in the exemplifying figure, be attached to the cylindrical enclosure at the open enclosure end 10b. Thus, the lid 1 may form the second enclosure end 10b. Alternatively, both the first enclosure end 10a and the second enclosure end 10b may be formed by respective lids.

The cell 10 of FIG. 1a is of a type that has both a positive terminal and a negative terminal at one and the same end 10a of the cylindrical secondary cell 10. The first enclosure end 10a comprises a central terminal through-hole 12 for the positive terminal (not shown). The negative terminal is comprised by the cylindrical enclosure 11.

A cell 10 having both terminals at one end/having the cylindrical enclosure 11 as a terminal may bring advantages as regards electrically connecting the cell to a load. Conductors electrically connecting the terminals to the load may be positioned on the same end, the first enclosure end 10a, of the cell. The opposite end, referred to as the second enclosure end 10b, of the cell 10 may be dedicated to electrolyte filling and venting. An overpressure may be generated within the cell during operation, in particular upon malfunction of the cell or of the load connected to the cell. Such malfunction may require a release of gas and/or other ejecta out of the cell, and it may be advantageous to direct the released gas and/or other ejecta away from the conductors, i.e. out from the second enclosure end 10b, that is opposite to the first enclosure end 10a.

A number of cells 10 may be positioned close to the bottom of an electric vehicle. The cells 10 may be arranged with the first enclosure ends 10a directed away from the ground and the second enclosure ends 10b directed towards the ground. Upon malfunction, for example resulting from a faulty electric vehicle charger or a faulty cell 10, a release of gas and/or other ejecta from the second enclosure ends 10b will be advantageously directed downwards towards the ground beneath the vehicle. In other applications than vehicles, the second enclosure ends 10b may be directed towards a desired location such that any gas and/or other ejecta will not cause damages or injuries.

As is illustrated in FIG. 1a, the cell 10 comprises an electrode roll 20. The electrode roll 20 comprises a first and a second conductive sheet 21, 22 and separating means (not shown). The conductive sheets 21, 22 and the separating means are rolled to form a circular cylindrical roll, the electrode roll 20. The conductive sheets 21, 22 are coated with electrode coatings and on assembly of the cell 10, the cylindrical enclosure 11 is filled with an electrolyte. The coatings on the conductive sheets 21, 22 act as cathode and anode, respectively. The cathode, anode and electrolyte provide electrochemical energy storage. This principle is known per se, and the electrode roll 20 is commonly referred to as a jellyroll.

The conductive sheets 21, 22 of the electrode roll 20 may be axially offset in relation to one another, and each conductive sheet 21, 22 may comprise an end section that is not coated with electrode coating. Via the non-coated end sections, the respective ends of the electrode roll may be efficiently electrically connected to a current collector disc 15 or a terminal (not shown). This design is known per se and commonly referred to as a tabless cell.

As is understood from FIG. 1a, one of the conductive sheets 22 is arranged to be in direct electrical contact with the current collector disc 15. Direct electrical contact may be referred to as physical contact.

Furthermore, the lid 1 is arranged to be in direct electrical contact with the current collector disc 15. As seen in FIG. 1a, the lid 1 comprises recessed contact portions 2. The recessed contact portions 2 on the lid 1 are in direct electrical contact with the current collector disc 15. As previously mentioned, the lid 1 may be welded to the current collector disc 15, with the recessed contact portions 2 as a weld interface. The attached lid 1 and the current collector disc 15 may then be arranged in the cylindrical enclosure 11. The lid 1 is attached to the cylindrical enclosure 11. For example, this attachment can be formed by welding. When the lid 1 is attached to the cylindrical enclosure 11, the cylindrical enclosure 11 is enclosed, forming a cell 10.

FIG. 1b shows a cross-sectional view of an example cylindrical secondary cell 10, in accordance with FIG. 1a. One difference is that in FIG. 1b the current collector disc 15 comprises the recessed contact portions 2. The lid 1 comprises a flange 6 extending in parallel with the cylindrical enclosure 11. Further, the flange 6 is attached to the cylindrical enclosure 11. For example, the flange 6 is attached to the cylindrical enclosure 11 with welding. The flange 6 acts as the welding interface, and the weld seam can be inspected after weld to ensure that it is proper.

The recessed contact portions 2 on the current collector disc 15 are in direct electrical contact with the electrode roll 20. Further, the “protruding” parts 3 opposite to the recessed contact portions 2 of the current collecting disc 15 are in direct electrical contact with the lid 1.

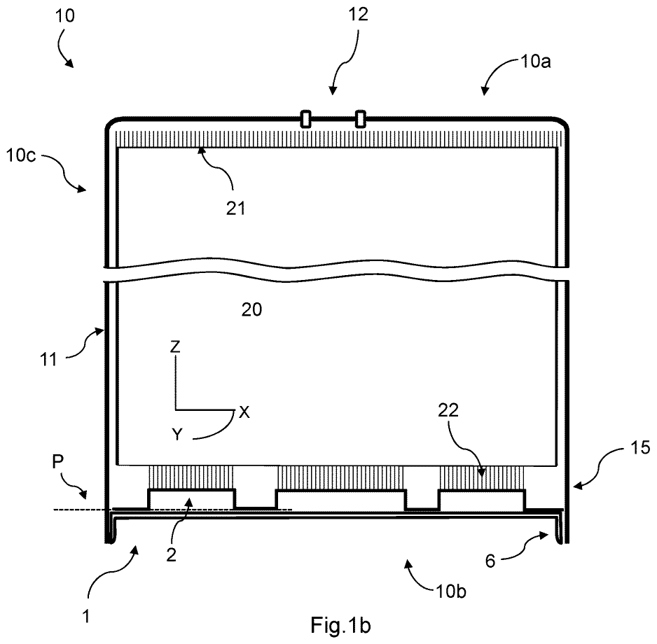

FIGS. 2a-c shows cross-sectional views of a portion of an example cylindrical secondary cell wherein a lid 1 and a current collector disc 15 are attached to a cylindrical enclosure 11. FIG. 2a shows an example where both the lid 1 and the current collector disc 15 comprises recessed contact portions 2a and 2b, respectively. The conductive sheet 22 is in electrical contact with the recessed contact portions 2b of the current collector disc 15. The recessed contact portions 2a of the lid 1 conforms with the recessed contact portions 2b of the current collector disc 15.

FIG. 2b shows an example where both the lid 1 and the current collector disc 15 comprises recessed contact portions 2a and 2b, respectively. The recessed contact portions 2a and 2b are arranged opposite to each other, i.e. forming a cavity 2c between each recessed contact portion 2a and 2b. Similarly to the example shown in FIG. 2a, the conductive sheet 22 is in electrical contact with the recessed contact portions 2b of the current collector disc 15.

FIG. 2c shows an example where both the lid 1 and the current collector disc 15 comprises recessed contact portions 2a and 2b, respectively. The recessed contact portions 2a and 2b are arranged to abut each other, i.e. the recessed contact portions 2a and 2b are in electrical contact. Further, the non-recessed portions of the current collector disc 15 is facing the conductive sheet 22. Thus, the non-recessed portions of the current collector disc 15 are in electrical contact with the conductive sheet 22.

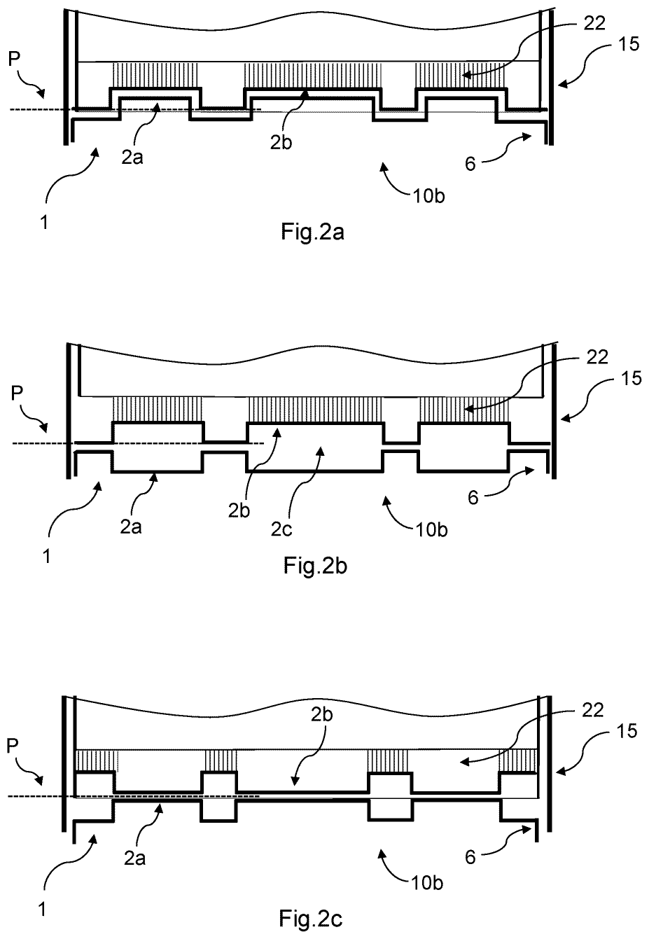

FIG. 3 shows a perspective view of a lid 1 with recessed contact portions 2. The lid 1 has a number of recessed contact portions 2 that are configured to form the direct electrical contact with the current collector disc 15. The recessed contact portions 2 are integral portions of the lid 1.

Each individual recessed contact portion 2 preferably covers a majority of the area of the lid 1 in order to increase the electrical connection area with the current collector disc 15. An increased size of the area comprised by the recessed contact portions 2 is beneficial as it simplifies positioning of the weld, e.g. laser weld lines, within the recessed contact portion 2.

For example, each recessed contact portion 2 may have an area of 5 to 15 percent, or 7 to 11 percent, of the total area of the cylindrical secondary cell lid 1. With such area ranges, there may be six recessed contact portions 2. In this disclosure, the area of the recessed contact portion 2 is the area that is in direct electrical contact with the current collector disc 15.

In another example, each recessed contact portion may have an area of 10 to 30 percent, or 15 to 30 percent, of the total area of the cylindrical secondary cell lid 1. With such area ranges, there may be three recessed contact portions 2.

Preferably, the total area of the recessed contact portions 2 is 50 to 80 percent of the total area of the lid 1. Other numbers of recessed contact portions are conceivable, such as four.

The recessed contact portions 2 may be, as is shown, equidistantly distributed along the circumference of the lid 1. Such a pattern may be beneficial in assembly of the cell and for positioning the welds.

Each one of the recessed contact portions 2 may be of the same size, as is shown herein. Further, the recessed contact portions 2 may each have essentially the same extension (dimension or length) radially and circumferentially to facilitate welding.

The smallest extension of the respective recessed contact portion 2 may be at least 20 percent of the total extension of the lid 1. The radial extension of the recessed contact portions 2 is preferably maximized, such that the electrical connection area between the lid 1 and the current collector disc 15 can be maximized, and thereby, minimizing an internal resistance of the cell 1.

In other embodiments (not shown), not all recessed contact portions 2 are of the same size. For example, there may be larger recessed contact portions 2 that are welded to the current collector disc 15, and smaller recessed contact portions 2 that are not welded to the current collector disc 15. The smaller recessed contact portions 2 may support the current collector disc 15, but not be attached to the current collector disc 15. An irregular (sizes or positioning) pattern of recessed contact portions 2 may be beneficial in manufacture, as such a pattern may facilitate vision systems identifying the orientation of the lid 1. The vision systems may be used for controlling welding apparatuses to arrange the welds at desired locations.

Each respective recessed contact portion 2 may be substantially rectangular or substantially square-shaped. More precisely, each recessed contact portion 2 may be substantially trapezoidal.

Referring to FIG. 3, the recessed contact portions 2 comprise first and second circumferential sides 2a, 2b and first and second radial sides 2c, 2d.

The first circumferential side 2a of each respective recessed contact portion 2 may extend concentrically with the lid 1. Thus, the first circumferential side 2a may be curved, more precisely arcuate or circular arcuate. The first circumferential side 2a may be positioned essentially mid-way between the outer radial end (or circumferential edge) of the lid 1 and the center of the lid. In the present example, the first circumferential side 2a extends approximately 40 to 60 degrees around the 360 degrees circumference of the lid.

The second circumferential side 2b of each respective recessed contact portion 2 may extend concentrically with the lid 1 and thus with the first circumferential side 2a. The second circumferential side 2b may be curved, more precisely arcuate or circular arcuate. The second circumferential side 2b may be positioned close to the outer radial end (or circumferential edge) of the lid 1. The distance between the second circumferential side 2 b and the outer radial end may correspond to 5 to 20 percent of the radius of the lid 1, preferable approximately 15 percent. In the present example, the second circumferential side 2b extends approximately 40 to 60 degrees around the 360 degrees circumference of the lid.

As illustrated in FIG. 3, the recessed contact portions 2 are positioned closer to the outer radial end of the lid 1 than to the center of the lid 1. The first radial side 2c of the respective recessed contact portion 2 extends from a first end of the first circumferential side 2a to a first end of the second circumferential side 2b. The first radial side 2c is straight. In the present example, the first radial side extends approximately 25 to 40 percent of the radius of the lid 1. The first radial side 2c is aligned with the radial direction of the lid 1.

The second radial side 2d of the respective recessed contact portion 2 extends from a second end of the first circumferential side 2a to a second end of the second circumferential side 2b. The second radial side 2d is straight. In the present example, the second radial side extends approximately 25 to 40 percent of the radius if the lid 1. The second radial side 2d is aligned with the radial direction of the lid 1.

The sides 2a, 2b, 2c, 2d and the respective corners formed where the sides meet are rounded (radially and axially), as is shown. Thus, the transition between the recessed contact portions 2 and the surrounding area of the lid 1 can be rounded or smooth. This design is beneficial for manufacturing purposes and for reducing mechanical and electrical stress concentrations. The contact area of a recessed contact portion 2 is measured on the surface of the recessed contact portion 2 that faces the current collector disc 15.

According to FIG. 3, the lid 1 further comprises a groove or notch 4 for providing an opening in the lid 1 if a pressure to which the lid is subjected reaches a threshold value. In other words, the groove or notch 4 is to provide an opening in the lid 1 when the lid 1 is attached to the cylindrical enclosure 11, if the pressure inside the cylindrical enclosure reaches a threshold value. In such a situation, gas and/or other ejecta may be released out of the cell 10 through the opening formed in the lid 1. The opening formed in the lid 1 as a result of the groove or notch 4 breaking may be referred to as a vent opening.

The groove or notch 4, which may be referred to as a breakable portion, may be thinning of the lid material that is configured to break before other parts of the lid 1 (and the cylindrical enclosure). The notch 4 may be circular and may at least partly encircle a central portion of the lid 1.

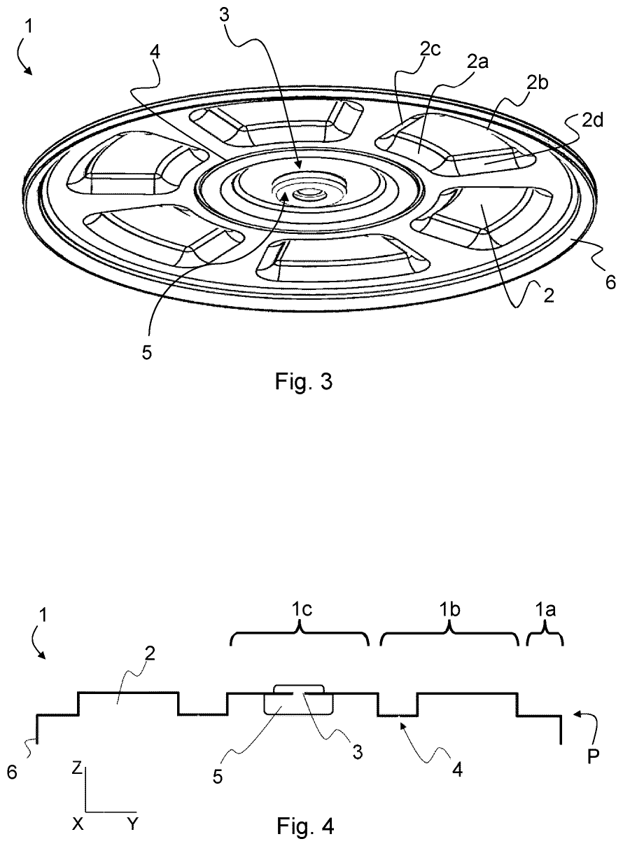

FIG. 4 shows a cross-sectional view of a lid 1 or a current collector disc 15 comprising recessed contact portions 2. The lid 1 or current collector disc 15 comprises three separate regions 1a, 1b, 1c. These regions are radially separated and thus do not overlap. The regions 1a, 1b, 1c are formed in one piece. The regions 1a, 1b, 1c are all made in one piece and together form the lid 1 or the current collector disc 15. The lid 1 or the current collector disc 15 may for example be formed by pressing a circular piece of sheet metal.

The radially outer region 1a, forms the radially outermost section of the lid 1 or the current collector disc 15. The radially outer region 1a encircles a radially intermediate region 1b, that forms an intermediate region of the lid 1 or current collector disc 15. The radially intermediate region 1b encircles a radially inner region 1c, that forms an inner region of the lid 1 or current collector disc 15. In the example shown in FIG. 4, the radially outer, intermediate and inner regions 1a, 1b, 1c are concentric. Further, the radially outer region 1a is annular. The radially inner region 1c is circular. Further, there may be a fill opening 3 arranged within the inner region 1c is, and therefore the inner region 1c may also be annular.

Moreover, the radially inner region 1c comprises a fill opening 3 for electrolyte filling. The radially inner region 1c is recessed. The recessed radially inner region 1c extends in the same plane as the recessed contact portions 2. The filling opening 3 is sealed by a sealing element 5, for example a rivet. If the radially inner region 1c is recessed, the sealing element 5 is countersunk such that it does not protrude axially beyond the enclosure end 10b to which the lid 1 is attached. The sealing element 5 may be countersunk by the recessed radially inner region 1c such that it does not protrude from the area of the lid 1 that surrounds the radially inner region 1c, or protrudes (axially) from the circumferential edge of the lid 1. The electrode roll 20 (not shown in this figure) comprises a central electrolyte channel or void into which the sealing element 5 may protrude.

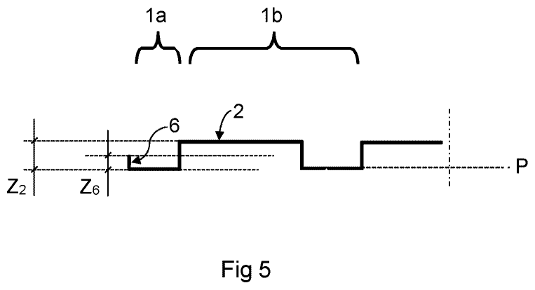

FIG. 5 shows a cross-sectional view of a portion of a lid 1 or a current collector disc 15 with recessed contact portions 2 and a flange 6. The radially outer region 1a is configured to be attached to the cylindrical enclosure 11. The radially outer region 1a is further configured to be arranged in direct electrical contact with the cylindrical enclosure 11, e.g. by welding.

The radially outer region 1a comprises a flange 6. In one example, the flange 6 is used for welding the lid 1 or the current collector disc 15 to the cylindrical enclosure 11. Further the flange 6 can be used for welding the lid 1 and the current collector disc 15 to each other. However, there are other methods for attaching a lid to a cylindrical enclosure of a cell.

Further, the notch 4 (not shown in this figure) is comprised in the radially intermediate region 1b.

The lid 1 may be generally disc-shaped. The lid 1 may have the general shape of a circular plate. The lid 1 may comprise a circular disc that at the radially outer end comprises the above-described flange. According to FIG. 5, the flange 6 extends from the circular disc in a direction away from the cylindrical enclosure 10 (when the lid 1 is attached to the cylindrical enclosure 10), see FIGS. 1 to 3. Alternatively, the flange 6 may also extend in a direction towards the cylindrical enclosure 10. The circular disc and the flange 6 may be formed in one integral piece.

The recessed contact portions 2 are recessed in relation to a base plane P of the lid 1. The base plane P is indicated in FIGS. 2 to 4, and is described as the plane from which the recessed contact portions 2, the flange 6, and the inner region 1c protrude. Each individual recessed contact portion 2 protrudes separately. The recessed contact portions 2 are recessed in the (axial, Z-axis) direction that faces the electrode roll 20, towards the electrode roll. Also, the inner region 1c may be recessed in the direction that faces the electrode roll 20, towards the electrode roll.

The axial extension, or protrusion or height, of the recessed contact portions 2 may correspond to the recessed height of the inner region 1c. The inner region 1c may mechanically support the electrode roll 20. The height of the recessed contact portions 2 may correspond to the height of the flange 6.

The recessed contact portions 2 may have essentially the same height as the flange 6, as is shown in FIGS. 2 and 3. In some embodiments, the recessed contact portions 2 may have a height that exceeds the height of the flange 6, the recessed contact portions 2 may for example be two or three times the height of the flange 6. In some embodiments, the flange 6 may have a height that correspondingly exceeds the height of the recessed contact portions 2.

The recessed contact portions 2 may have the same height as the recessed inner region 1c. In some embodiments, the recessed contact portions 2 may have a height that exceeds the height of the recessed inner region 1c. In some embodiments, the recessed inner region 1c may have a height that exceeds the height of the recessed contact portions 2.

As seen in FIG. 5, the axial extension Z2 of the recessed contact portions 2 is approximately two times the axial extension Z6 of the flange 6. In another embodiment (not shown), the axial extension Z2 of the recessed contact portions 2 is approximately three times the axial extension Z6 of the flange 6. With such a design (Z2>Z6), the risk of electrical contact between the electrode roll 20 and the flange 6 is decreased.

While the present disclosure is susceptible to various modifications and alternative forms, specific examples are shown and described in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims, including the possible combination of various elements of these specific examples.

1. A cylindrical secondary cell (10) comprising:
a cylindrical enclosure (11) having a lid (1),
an electrode roll (20) arranged in the cylindrical enclosure (11), and
a current collector disc (15) arranged in direct electrical contact with the electrode roll (20) and configured to be attached to the lid (1),
wherein:
the lid (1) or the current collector disc comprises a number of recessed contact portions (2), the area of the recessed contact portions (2) being 50 to 80 percent of the total area of the lid (1) or current collector disc (15).

2. The cylindrical secondary cell (10) of claim 1, wherein the lid (1) is configured to be attached to the cylindrical enclosure (11) by an attachment between the current collector disc and the lid (1).

3. The cylindrical secondary cell (10) of claim 1, wherein the lid (1) is configured to be attached to the cylindrical enclosure (11) by the lid (1) being welded to the current collector disc (15).

4. The cylindrical secondary cell (10) of claim 3, wherein the lid (1) and the current collector disc (15) extend substantially in parallel.

5. The cylindrical secondary cell (10) according to claim 1, wherein the lid (1) and the current collector disc (15) are welded to the cylindrical enclosure (11).

6. The cylindrical secondary cell (10) of claim 3, wherein a weld interface (30) between the lid (1) and the current collector disc (15), after welding, is at least partly visible such that the weld may be inspected.

7. The cylindrical secondary cell (10) of claim 6, wherein the weld interface is comprised by the recessed contact portions (2).

8. The cylindrical secondary cell (10) of claim 1, wherein the lid (1) further comprises a flange (6) to be arranged in direct electrical contact with the cylindrical enclosure (11) of the cylindrical secondary cell (10), wherein the extension (Z2) of the recessed contact portions (2) in a longitudinal direction (Z) of the cylindrical secondary cell (10) substantially equals the extension (Z6) of the flange (6) in the longitudinal direction (Z) of the cylindrical secondary cell (10).

9. The cylindrical secondary cell (10) of claim 8, wherein the recessed contact portions (2) and the flange (6) extend in the same axial direction.

10. The cylindrical secondary cell (10) of claim 1, wherein the extension (Z2) of the recessed contact portions (2) in the longitudinal direction (Z) of the cylindrical secondary cell (10) exceeds the extension (Z6) of the flange (6) in the longitudinal direction (Z) of the cylindrical secondary cell (10).

11. A method for assembling the cylindrical secondary cell (10) of claim 1, the method comprising
arranging the current collector disc (15) in direct electrical contact with the electrode roll (20),
attaching the lid (1) to the current collector disc (15).

12. The method according to claim 11, further comprising:
attaching the lid (1) to the current collector disc (15) by welding; attaching the lid (1) welded to the current collector disc (15) to the electrode roll (20).

13. The method for assembling a cylindrical secondary cell (10) according to claim 11, further comprising:
arranging the current collector disc (15) in the cylindrical enclosure (11),
arranging the lid (1) on the current collector disc (15) in the cylindrical enclosure (11),
attaching the lid (1) to the current collector disc (15) by welding from a top surface of the lid (1), such that the lid (1) and the current collector disc (15) are welded together in the cylindrical enclosure (11).

14. The cylindrical secondary cell (10) of claim 2, wherein the lid (1) is configured to be attached to the cylindrical enclosure (11) by the lid (1) being welded to the current collector disc (15).

15. The cylindrical secondary cell (10) of claim 14, wherein the lid (1) and the current collector disc (15) extend substantially in parallel.

16. The cylindrical secondary cell (10) of claim 4, wherein a weld interface (30) between the lid (1) and the current collector disc (15), after welding, is at least partly visible such that the weld may be inspected.
